(19) United States
(12) Patent Application Publication
(10) Pub. No.: US 2014/0113162 A1
(43) Pub. Date: Apr. 24, 2014

(54) METHOD AND ARRANGEMENT FOR MINIMIZING NEED FOR SAFETY GASES

(71) Applicant: Convion Oy, Espoo (FI)

(72) Inventors: Tero HOTTINEN, Lohja (FI); Kim ÅSTRÖM, Kirkkonummi (FI); Marko Laitinen, Vantaa (FI)

(73) Assignee: Convion Oy, Espoo (FI)

(21) Appl. No.: 14/142,245

(22) Filed: Dec. 27, 2013

Related U.S. Application Data
(63) Continuation of application No. PCT/FI2012/050676, filed on Jun. 28, 2012.

(30) Foreign Application Priority Data
Jun. 30, 2011 (FI) 20115685

(51) Int. Cl. H01M 8/04

(52) U.S. Cl. CPC H01M 8/04
USPC 429/9; 429/428; 429/444

(57) ABSTRACT

An arrangement is disclosed for reducing use for safety gases in a high temperature fuel cell system, each fuel cell in the fuel cell system including an anode side, a cathode side, and an electrolyte between the anode side and the cathode side. The fuel cells can be arranged in fuel cell stacks. The fuel cell system can include a fuel cell system piping for reactants, and feeding of fuel to the anode sides of the fuel cells. Electrical anode protection can be achieved by supplying a predefined voltage separately to at least two fuel cell stacks or groups of fuel cell stacks to prohibit oxidation of anodes.

### RELATED APPLICATIONS

This application claims priority as a continuation application under 35 U.S.C. §120 to PCT/FI2012/050676, which was filed as an International Application on Jun. 28, 2012 designating the U.S., and which claims priority to Finnish application No. 20115685 filed in Finland on Jun. 30, 2011. The entire contents of these applications are hereby incorporated by reference in their entireties.

### FIELD

Energy of the world is produced by, for example oil, coal, natural gas or nuclear power. All of these production methods can have issues regarding, for example, availability and friendliness to the environment. Regarding the environment, oil and coal can for example cause pollution when combusted. Nuclear power involves an issue regarding, at least, storage of used fuel.

Due to environmental issues, new energy sources, which are more environmentally friendly and, for example, have better efficiency than the above-mentioned energy sources, have been developed. Fuel cell devices can be promising for future energy conversion device by which fuel, for example bio gas, can be directly transformed to electricity via a chemical reaction in an environmentally friendly process.

### BACKGROUND INFORMATION

A fuel cell, as presented in FIG. 1, includes an anode electrode side 100 and a cathode electrode side 102 and an electrolyte material 104 between them. As the arrows in FIG. 1 symbolize, fuel 116 is fed to the anode side and air 106 is fed to the cathode side, and thus the cathode electrode is also called an “air electrode”. In solid oxide fuel cells (SOFCs), oxygen (for example air 106) is fed to the cathode side 102 and it is reduced to a negative oxygen ion by receiving electrons from the anode via an external electrical circuit 111. The negative oxygen ion goes through the electrolyte material 104 to the anode side 100 where it reacts with the fuel 116 producing water and, for example, carbon dioxide (CO2). Between anode 100 and cathode 102 is the external electric circuit 111 including a load 110 for the fuel cell.

FIG. 2 shows a SOFC device as an example of a high temperature fuel cell device. A SOFC device can utilize as fuel for example natural gas, bio gas, methanol or other compounds containing hydrocarbon mixtures. The SOFC device in FIG. 2 includes more than one (e.g., plural) fuel cells in stack formation 103 (i.e., an SOFC stack). Each fuel cell includes the anode 100 and the cathode 102 structure as presented in FIG. 1.

Part of the used fuel is recirculated in feedback arrangement 109 through each anode. By using measurement means 115 (such as a fuel flow meter, current meter and temperature meter) desired measurements from the gas can be obtained which can be recirculated through the anode sides 100. Only part of the gas used at the anode sides 100 is recirculated through anodes in feedback arrangement 109 and the other part of the gas is exhausted as exhaust 114 from the anodes 100.

The FIG. 2 SOFC device can also include fuel heat exchanger 105 and reformer 107. Heat exchangers can be used for controlling thermal conditions in a fuel cell process and there can be located more than one of them in different locations of the SOFC device. The extra thermal energy in circulating gas is recovered in one or more heat exchangers 105 to be utilized in a SOFC device or outside heat recovering unit.

Reformer 107 is a device that converts the fuel, such as for example natural gas, to a composition suitable for fuel cells; for example to a composition containing hydrogen and methane, carbon dioxide, carbon monoxide and inert gases. In each SOFC device, it is not necessary to have a reformer.

A solid oxide fuel cell (SOFC) device is an electrochemical conversion device that produces electricity directly from oxidizing a fuel. Exemplary advantages of an SOFC device include high efficiencies, long term stability, low emissions, and cost. An exemplary disadvantage is a high operating temperature which can result in long start up times, and both mechanical and chemical compatibility issues. Solid oxide fuel cells (SOFC) operate at temperatures of 600-1000° C.

The anode electrode of a solid oxide fuel cell (SOFC) can contain significant amounts of nickel that can be vulnerable to forming of nickel oxide if the atmosphere is not reducing. If nickel oxide formation is severe, the morphology of an electrode can be changed irreversibly, causing significant loss of electrochemical activity or even break down of cells.

Hence, SOFC systems can include safety gas containing reductive agents (e.g., hydrogen diluted with an inert gas such as nitrogen) during the start-up and shut-down, in order to prevent the fuel cell's anode electrodes from oxidation. In practical systems the amount of safety gas is minimized because extensive amounts of, for example pressurized gas containing hydrogen, can be expensive and problematic as space-requiring components.

Oxidation of anodes can be addressed by maintaining a reducing atmosphere in the anode flow channels. Reducing conditions can be maintained by feeding fuel or other reducing species such as hydrogen containing gas at a rate sufficient to reduce all oxygen arriving to the anodes. If the reducing gas has a high hydrogen (or hydrogen equivalent) content, desired flows can be relatively small and if an ordinary fuel can be used, no additional gas source is required.

By suitable process and safety arrangements, ordinary fuel can be used for maintaining a reducing atmosphere at the anodes during normal operations as well as during start-up and controlled shutdown. However, in the case of an emergency shutdown (ESD) due to for example a gas alarm, all feed of combustible gases should be immediately discontinued. If hydrogen is still desired at the anodes, it should be supplied in the form of a dilute mixture with sufficiently low hydrogen content so as not to form an explosive mixture with air in any mixing proportions. For a hydrogen-nitrogen mixture, the hydrogen content should be no higher than 5% to meet this criterion. This increases the desired volume flow to 20-fold compared to a feed of pure hydrogen.

According to known applications, an amount of runtime reactants during normal start-up or shut-down can be minimized by anode recirculation; i.e., circulating the non-used safety gas back to the loop, as there is simultaneous desire for minimization of the runtime reactants and heating time in the start-up situation, and also simultaneous desire for minimization of the runtime reactants and cooling of the system in the shut-down situation. It is also possible to minimize start-up heating time in the recirculation process, because also heat can be recirculated in the process together with the non-used gas.

However, in emergency shut-down (ESD) that can be caused for example by a gas alarm or black-out, there will not be active recirculation available increasing the amount of desired safety gas. In addition, the cathode air flow is not cooling the system during the ESD, because the air blower has to be shut down, and hence the amount of desired safety gas is even further increased as the time to cool the system down to temperatures where nickel oxidation does not occur is even three-fold compared to active shut-down situation.

In the ESD situation the total amount of gas can be determined by the time determined for the system to cool down to below the anode oxidation temperatures. Since no active cooling mechanism can be available during the emergency cool-down, the cooling time can be up to tens of hours for a well-insulated system. This implies the need for a large safety gas storage in conjunction with the fuel cell unit. In addition to added cost, the gas storage also significantly increases the space requirement for the fuel cell system installation. Moreover, the gas storage and delivery logistics (bottle or bottle rack replacements) pose additional demands on the fuel cell system environment and cost for each replacement. All together the need for a massive amount of purge gas (i.e., safety gas) can be a significant obstacle for the feasibility of fuel cell systems in many applications.

Patent application document US2002/028362 discloses anode oxidation protection methods in a high temperature fuel cell system during shut downs or fuel loss events. In one method of US2002/028362 maintains a reducing atmosphere around an anode of a molten carbonate or solid oxide fuel cell by: (a) monitoring the electrical potential generated by the fuel cell; and (b) applying an external electrical potential across the fuel cell, such that electric current flows through the fuel cell in a direction opposite to current flow during normal operation of the fuel cell, whenever the voltage output of the fuel cell drops below a predetermined level.

An external power source is applied after droppings below the predetermined voltage level which, in practice, is a substantially low voltage level. At least in lower operating temperatures these kind of embodiments are not successful to prevent anode oxidation. In emergency shutdown situations (ESD), the described methods are not applied.

### SUMMARY

An arrangement for reduced use of safety gases in a high temperature fuel cell system, comprising: fuel cells in the fuel cell system, each fuel cell having an anode side, a cathode side, and an electrolyte between the anode side and the cathode side, the fuel cells being arranged in fuel cell stacks; a fuel cell system piping for reactants; means for feeding fuel to the anode sides of the fuel cells; means for electrical anode protection by supplying a predefined voltage separately to at least two groups of fuel cell stacks to inhibit oxidation of anodes; a back-up source of energy sufficient for providing electrical energy for at least a predetermined minimum time for said means for electrical anode protection; means for separately preventing anode protection current from exceeding a predefined maximum current value for stack group specific electrical anode protection in case of faulty stacks; means for triggering said means for electrical anode protection in a situation where anode oxidation cannot be prohibited by the means for feeding fuel to the anode sides of the fuel cells; means for allowing for explosion safe operation in a presence of an explosive atmosphere; and means to de-energize specified non-safe equipment.

A method for reduced use of safety gases in a high temperature fuel cell system, the method comprising: feeding fuel to anode sides of fuel cells of the fuel cell system; obtaining predefined voltage and current values; performing electrical anode protection by supplying the predefined voltage in separate routes to at least two groups of fuel cell stacks to inhibit oxidation of anodes; providing electrical energy from a back-up source of energy for at least a predetermined minimum time for the performing of said electrical anode protection; separately preventing the anode protection current from exceeding a predefined maximum current value for stack group specific electrical anode protection in case of faulty stacks; and triggering the performing of electrical anode protection in a situation where anode oxidation cannot be prohibited by feeding fuel to the anode sides of the fuel cells, an explosion safe operation being allowed in a presence of an explosive atmosphere, and specified non-safe equipment being de-energized.

### BRIEF DESCRIPTION OF THE DRAWINGS

FIG. 1 shows an exemplary single fuel cell structure;

FIG. 2 shows an exemplary SOFC device;

FIG. 3 shows an exemplary embodiment according to the present disclosure;

FIG. 4 shows an exemplary embodiment for electrical anode protection of fuel cell stacks; and

FIG. 5 shows another exemplary embodiment according to the present disclosure.

### DETAILED DESCRIPTION

A fuel cell system is disclosed where a risk of anode oxidation in shut-down situations can be reduced to reduce (e.g., minimize) the use of safety gases. This can be achieved by an arrangement for reducing (e.g., minimizing) a use of safety gases in a high temperature fuel cell system, where each fuel cell in the fuel cell system includes an anode side, a cathode side, and an electrolyte between the anode side and the cathode side, the fuel cells being arranged in fuel cell stacks.

The fuel cell system can include a fuel cell system piping for reactants, and means for feeding fuel to the anode sides of the fuel cells. The arrangement can include means for electrical anode protection supplying a predefined voltage separately to at least two fuel cell stacks or groups of fuel cell stacks to prohibit oxidation of anodes, a source of energy sufficient for providing electrical energy for at least a predetermined minimum time for the means for electrical anode protection, means to reduce the predefined voltage to limit anode protection current to a predefined maximum current value separately for at least two stacks or groups of stacks, and means to reliably trigger the means for electrical anode protection in a situation where anode oxidation cannot be prohibited by the means for feeding fuel to the anode sides of the fuel cells.

A method is disclosed for reducing (e.g., minimizing) use of safety gases in a high temperature fuel cell system, in which method fuel is fed to anode sides of the fuel cells, and predefined voltage and current values are obtained. In an exemplary method, electrical anode protection can be achieved by supplying a predefined voltage separately to at least two fuel cell stacks or groups of the fuel cell stacks to prohibit oxidation of anodes, electrical energy can be provided for at least a predetermined minimum time for performing electrical anode protection, a predefined voltage can be reduced to limit anode protection current to a predefined maximum current value separately for at least two stacks or groups of stacks, and a performing of electrical anode protection in a situation where anode oxidation cannot be prohibited by feeding fuel to the anode sides of the fuel cells can be reliably triggered.

Exemplary embodiments can include utilization of a source of energy sufficient for providing electrical energy for at least a predetermined minimum time for electrical anode protection, supplying a predefined voltage separately to at least two fuel cell stacks or groups of fuel cell stacks to prohibit oxidation of anode sides. The predefined voltage can be used to limit anode protection current to a predefined maximum current value separately to at least two stacks or groups of stacks. Furthermore, electrical anode protection can be reliably triggered in a situation where anode oxidation cannot be prohibited by feeding fuel to the anode sides of the fuel cells.

An exemplary benefit of disclosed embodiments is that significant savings in economic costs and in the physical size of the fuel cell system can be achieved in reducing the risk of anode oxidation in an emergency shutdown situation.

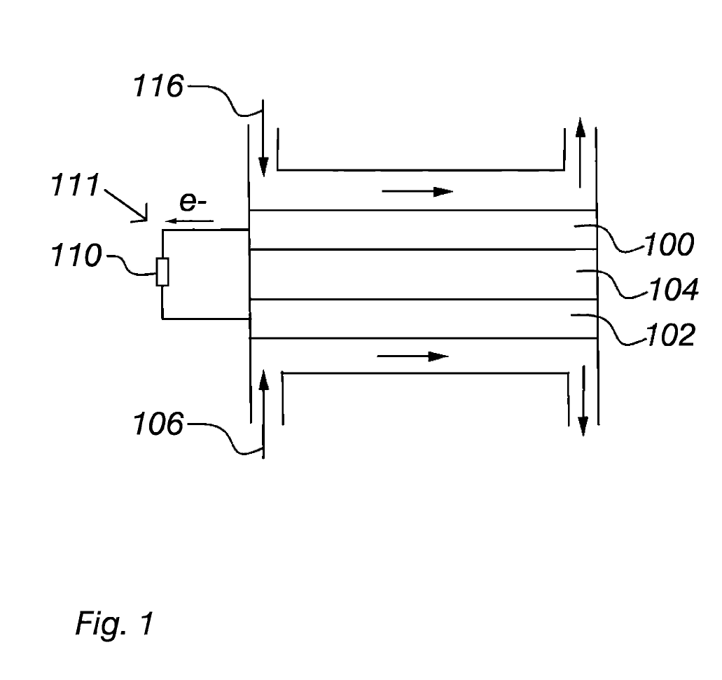

Solid oxide fuel cells (SOFCs) can have multiple geometries. A planar geometry as shown in FIG. 1 is an exemplary sandwich type geometry employed by many types of fuel cells, where the electrolyte 104 is sandwiched in between the electrodes, anode 100 and cathode 102. SOFCs can also be made in tubular geometries where for example either air or fuel is passed through the inside of the tube and the other gas is passed along the outside of the tube. The tubular design can be better in sealing air from the fuel. Performance of the planar design can be better than performance of the tubular design. However, the planar design can have a lower resistance comparatively.

Other geometries of SOFCs include modified planar cells (MPC or MPSOFC), where a wave-like structure replaces a flat configuration of the planar cell. Such designs can be promising, because they can include advantages of both planar cells (low resistance) and tubular cells.

Ceramics used in SOFCs may not become ionically active until they reach very high temperature and as a consequence of this the stacks can be heated at temperatures ranging from 600 to 1,000° C.

Reduction of oxygen 106 (FIG. 1) into oxygen ions occurs at the cathode 102. These ions can then be transferred through the solid oxide electrolyte 104 to the anode 100 where they can electrochemically oxidize the gas used as fuel. In this reaction, water and carbon dioxide byproducts can be given off as well as two electrons. These electrons then flow through an external circuit 111 where they can be utilized to produce electrical current. The cycle can then repeat as those electrons enter the cathode material 102 again.

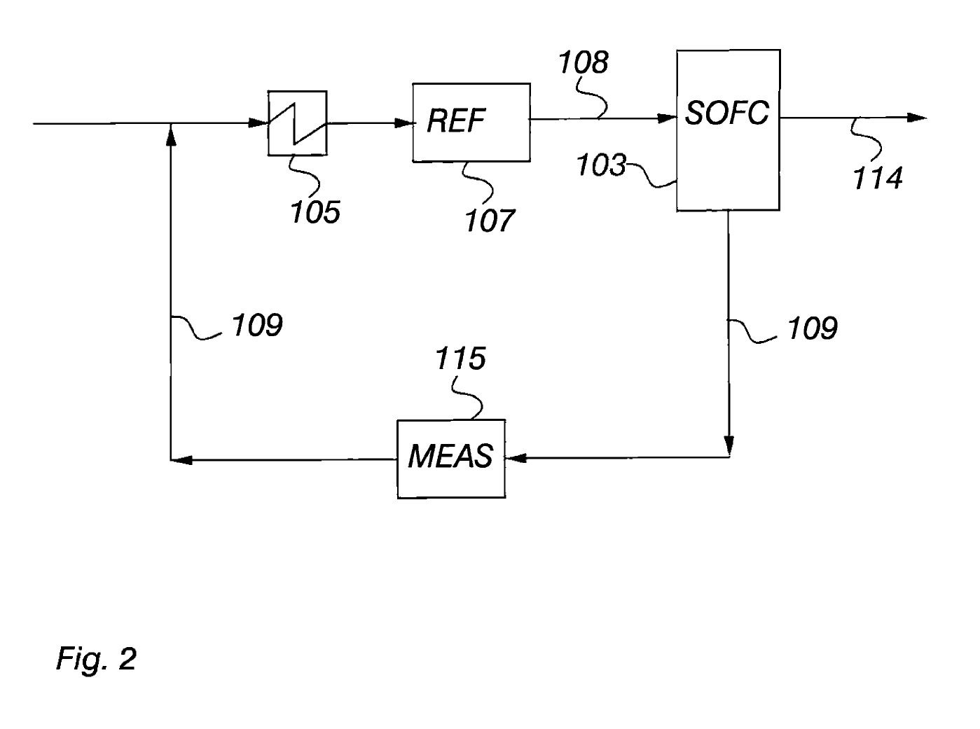

In larger solid oxide fuel cell systems, fuels can be natural gas (mainly methane), different biogases (mainly nitrogen and/or carbon dioxide diluted methane), and other higher hydrocarbon containing fuels, including alcohols. Fuel is fed to the anode sides by means 108 (in FIGS. 2, 3, 5) for feeding fuel, the means including for example suitable connection piping from a fuel source containing fuel to the anode sides 100 of the fuel cells 103.

Methane and higher hydrocarbons can be reformed either in the reformer 107 (FIG. 2) before entering the fuel cell stacks 103 or (partially) internally within the stacks 103. The reforming reactions can involve a certain amount of water, and additional water can also be desired to deter or prevent possible carbon formation (coking) caused by methane and, for example, higher hydrocarbons. This water can be provided internally by circulating the anode gas exhaust flow, because water is produced in excess amounts in fuel cell reactions, and/or the water can be provided with a separate water feed (for example, direct fresh water feed or circulation of exhaust condensate).

By an anode recirculation arrangement, part of the unused fuel and dilutants in anode gas can be fed back to the process, whereas in the separate water feed arrangement the only additive to the process is water.

Exemplary embodiments according to the present disclosure for deterring or preventing oxidation at the anodes can be arranged by maintaining a suitable electrical field across the cells, which can deter or prevent a nickel oxidation reaction from taking place. In order to maintain the field, a current can be supplied to the fuel cells. The magnitude of the current can correlate to an amount of oxygen arriving to the anodes.

In the following description with reference to the Figures, various techniques and methods to utilize electric anode protection during emergency shutdown conditions are presented.

Emergency shutdowns can be caused by a number of reasons internal or external to the fuel cell system, these reasons including gas leakages, grid outages and for example critical component failures. For example, since gas leakage is one of the potential causes causing emergency shutdowns, the fuel cell system should be of an explosion-safe type.

For electrical equipment this implies a desire for EX-classification, zone 2 (occurrence of explosive atmosphere is rare) or better. If electric anode protection is to be used in emergency shutdown conditions, it should be shown that it does not increase the risk of an explosion for each of the affected parts including: fuel cell stacks, current collection and cabling, electrical circuitry and source of energy.

With respect to the fuel cell stacks 103, the use of electrical anode protection has essentially no effect on explosion safety. Irrespective of whether the anodes can be protected by purge gas feed or electronically, the stacks will have a voltage close to OCV (open circuit voltage) as long as they can be hot. Levels of OCV can be, for example, between 1V-1.15 V depending on the stacks and operating temperatures. Stack surface temperatures will be essentially the same and initially for example well above self-ignition temperatures of likely leaking gases.

When the electric anode protection is equipped with current limiting features it can in fact reduce the risk of overheating caused by local leakages or stack short circuits. Hence, with respect to the fuel cell stacks explosion safety is not an obstacle for using electric anode protection during emergency shutdown condition.

For current collection essentially the same applies as for fuel cell stacks 103. Since circuit breakers cannot be placed in the hot environment, the hot part of stack current collectors and cables will carry the stack voltages and hence make no difference whether purging or electrical protection is used. The current used for electrical protection is at least an order of magnitude smaller than nominal fuel cell currents whereby the corresponding thermal load on the cabling is negligible.

For the cold parts of the current collection, known EX-practises can be applied. It is also emphasized that the protection current used for electrical anode protection is not same as current which is fed from the fuel cells 103 to an electrical network.

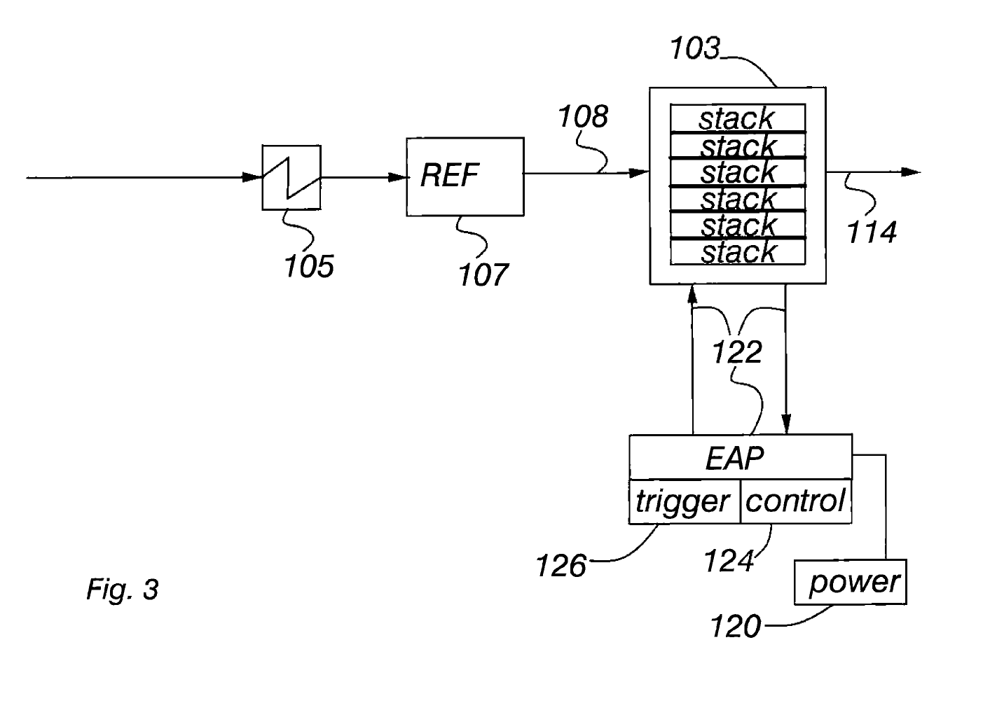

FIG. 3 shows an exemplary arrangement according to the present disclosure in a high temperature fuel cell system. The electronic circuitry 122 used to accomplish electrical protection (e.g., means 122 for electrical anode protection) can include means for converting the electrical energy from a source 120 to a controlled voltage and peak-limited current to be fed to the stacks 103. Thus, means 122 can include a power electronics circuitry. For EX-zones 1 and 2, for example, a flameproof enclosure can be utilized to comply with EX specifications.

Various sources 120 of energy can be used for providing the electrical power for the electrical anode protection. Exemplary options include batteries (for example, lead-acid, lithium), supply from an external UPS or safety supply AC or DC source (for example emergency power source in marine applications) and backup generators. Combinations of several sources can be used, for example feed from the grid safeguarded with batteries to cover for a grid outage of limited length.

Batteries or an emergency generator can be placed in a separate non-hazardous area in order to avoid the need for EX-classifications. At least for batteries, EX-approved enclosures can be also available. The source 120 of energy is sufficient for providing electrical energy for at least a predetermined minimum time for means 122 of electrical anode protection. The predetermined minimum time is based for example on fuel cell system calculations and/or fuel cell system measurements during or before the fuel system operation process.

Exemplary embodiments of the present disclosure can also include means 126 to reliably trigger the means 122 for electrical anode protection in a situation where anode oxidation cannot be prohibited by the means 108 for feeding fuel to the anode sides 100 of the fuel cells 103. Means 126 trigger (e.g., switch) the electrical anode protection on. Thus means 126 can be for example a trigger switch or trigger electronics to perform the trigger operation according to the disclosure. A command to perform the trigger operation can, for example, be given to the means 126 from power electronics control means 124 or from a fuel cell system control processor.

The amount of current used for maintaining a desired electrical field at the anode can depend on the level of leakage of the stacks and on the level of earth currents, etc., and for these purposes the present disclosure presents solutions to limit current values. An absolute desire for hydrogen can be determined in the electric anode protection by determining the amount of oxygen leakage, and on the basis of the oxygen amount a corresponding hydrogen amount can be determined. In an exemplary process according to the disclosure where combined electric anode protection and purging is utilized, the desired hydrogen amount can be provided by a determination for example in situations when only purging is in use in the process.

A conservative estimate for the current used for electrical anode protection in order to achieve the same level of protection as with only using purge gas can be obtained by assuming that all hydrogen in the purge gas is consumed. The estimate is conservative because specifications of purge gas amounts can have considerable safety margins when only a known purging process is used.

The safety margins have been set because of different kinds of uncertainty factors. The real need for hydrogen would be less, and thus the real level of current for electrical anode protection would also be less.

The voltage applied in electrical anode protection should be set such that neither nickel oxidation nor carbon formation will take place. Numerical values presented in the following approach can be based on experimental thermodynamic calculations (or similar kind of values) which can be also found from known literature. If a constant voltage is used, then this voltage should be close to for example 1.0V. If temperature information of the stacks is available, then the power consumption can be reduced by reducing the voltage down to 0.8V at high temperatures where currents can be expected to be highest.

In an exemplary embodiment of the disclosure, the power electronics control means 124 includes a stack resistance (ASR) measurement means for modulating the anode protection current for example by injecting a high-frequency AC (alternating current) signal on top of the DC (direct current) signal to obtain stack resistance information. The obtained stack resistance information can be used to approximate the stack temperature and then used to determine the appropriate electrical protection voltage value to be used without the need for an actual temperature measurement. The means 124 can for example obtain temperature values separately of the fuel cell stacks 103 by injecting a high frequency alternating voltage signal along with and on top of a direct current signal separately to each stack 103 or group of stacks to measure stack specific resistance information. Then individual temperature information can be determined for each stack or group of stacks on the basis of stack-specific resistance information, and the temperature information is utilized in limiting of current values used in a stack-specific electrical anode protection.

Further, the control means 124 can include means for reducing the predefined protection voltage to limit the protection current to a predefined maximum value in a stack-specific electrical anode protection in case of faulty stacks or short circuited stacks. In these situations the possible short circuit stack(s) do(es) not empty the whole usable protection current potential, and protection current can still be provided to the other stacks to prevent them from damage.

The other stacks can be thus kept in use by this kind of separate use arrangement according to the present disclosure. The predefinition of maximum current values is based at least on temperature information of the stacks 103, and the predefinition can be performed during or before the fuel system operation process. The means 124 for reducing the predefined voltage can include simple voltage reduction techniques according to known art or of more complicated voltage control techniques.

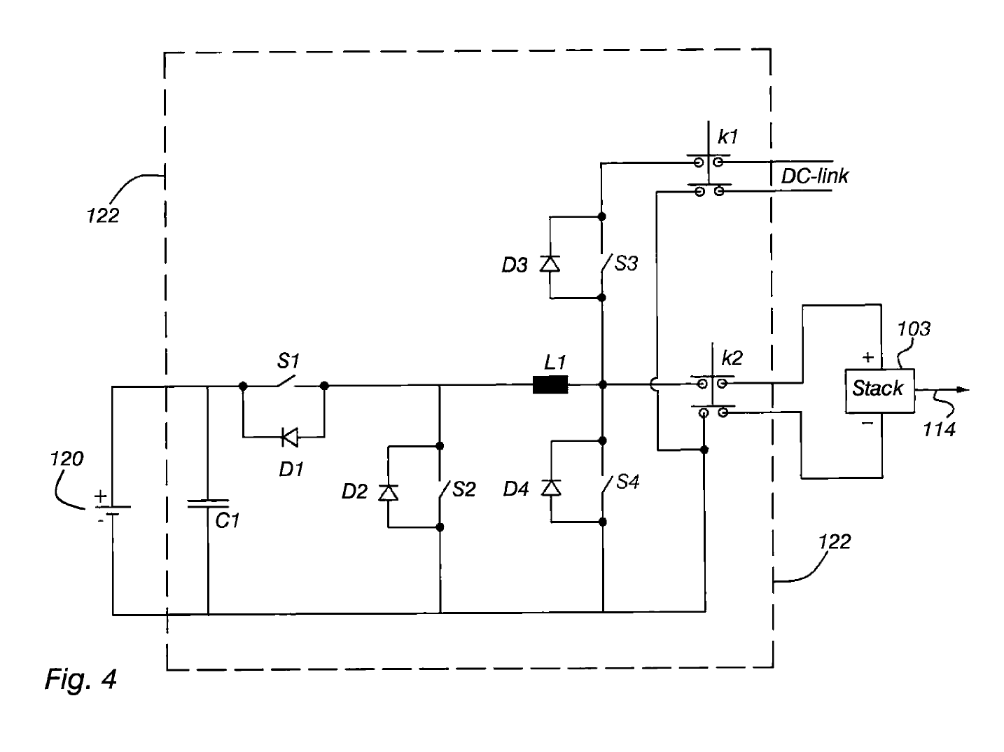

FIG. 4 shows an exemplary embodiment of means 122 for electrical anode protection of the fuel cell stacks. The means 122 can include diodes D1, D2, D3, D4, first switches S1, S2, S3, S4, second switches k1, k2, a capacitor C1 and an inductor L1. The diodes and the first switches can be in parallel connections. The means 122 can be connected to a DC-link via the second switch k1, to the fuel cell stacks 103 via the second switch k2, and to the source 120 of energy in parallel connection to the capacitor C1.

The means 122 can operate in a stack protection state when S1 and D2 can be active, k2 is closed and k1 is open. When a battery is used as the source 120 of energy, the means 122 operate in a battery charge state when S3 and D4 can be active, k1 is closed and k2 is open. Further the means 122 operate as a transient energy buffer, when S4 and D3 can be active, S1 is closed and k1 is closed.

In an exemplary embodiment of the disclosure, means 122 for electrical anode protection (e.g., the power electronics circuitry for electrical anode protection) can be connected to the stacks 103 continuously and be controlled by a single enable/disable signal. The presence of means 122 can allow for releasing requirements on minimum operation current of a main power converter (for example DC/DC) as the protection circuitry (i.e. means 122, can assist the fuel cell stacks 103 in delivering current during start of loading). Depending on the topology used in the main converter, the possibility to start up with a higher current allows for design simplifications and cost savings.

If the electrical anode protection power source 120 is implemented as a large battery pack then it can also be utilized to provide additional functionality to the fuel cell system. If connected to a main inverter it can act as a transient energy buffer in island mode operation and furthermore the fuel cell system can implement UPS (Uninterruptible Power Supply) functionality.

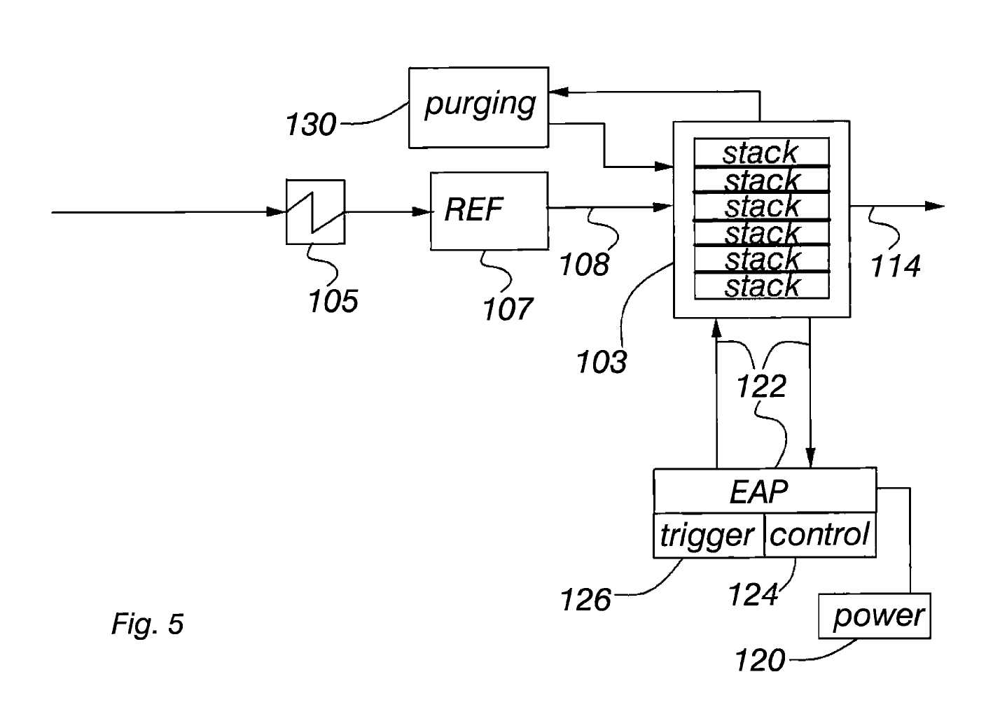

FIG. 5 shows another exemplary arrangement according to the present disclosure, which arrangement includes a pneumatic actuation arrangement 130 for purging operation in the emergency shutdown situation to minimize need for safety gases, together with the electric anode protection arrangement presented for example with respect to FIG. 3.

The arrangement 130 for purging operation is for example one of the purging arrangements presented in patent application FI20105196. Such a pneumatic actuation arrangement for spooling operation is for example located in the cathode side 102 of a high temperature fuel cell system for substantially reducing the need of purge gas (i.e., safety gas) in the anode side in the case of an emergency shut-down (ESD) situation, but the arrangement can also be applied in the anode side 100 or simultaneously both in the anode side 100 and the cathode side 102 of the high temperature fuel cell system. By this kind of combined purging and electrical anode protection arrangement, substantially smaller oxygen leakages can be achieved, and thus a considerably smaller source of energy 120 is sufficient for the electrical anode protection. For example, in a large volume fuel cell system the system size can be arranged substantially smaller and economical costs can be less than in a system using the electrical anode protection without the purging.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. An arrangement for reduced use of safety gases in a high temperature fuel cell system, comprising:
fuel cells in the fuel cell system, each fuel cell having an anode side, a cathode side, and an electrolyte between the anode side and the cathode side, the fuel cells being arranged in fuel cell stacks;
a fuel cell system piping for reactants;
means for feeding fuel to the anode sides of the fuel cells;
means for electrical anode protection by supplying a predefined voltage separately to at least two groups of fuel cell stacks to inhibit oxidation of anodes;
a back-up source of energy sufficient for providing electrical energy for at least a predetermined minimum time for said means for electrical anode protection;
means for separately preventing anode protection current from exceeding a predefined maximum current value for stack group specific electrical anode protection in case of faulty stacks;
means for triggering said means for electrical anode protection in a situation where anode oxidation cannot be prohibited by the means for feeding fuel to the anode sides of the fuel cells;
means for allowing for explosion safe operation in a presence of an explosive atmosphere; and
means to de-energize specified non-safe equipment.

2. An arrangement for reduced use of safety gases in a high temperature fuel cell system in accordance with claim 1, wherein the situation is an emergency shutdown situation, where anode oxidation cannot be prohibited by the means for feeding fuel to the anode sides of the fuel cells.

3. An arrangement for reduced use of safety gases in a high temperature fuel cell system in accordance with claim 1, wherein the arrangement comprises:
means for obtaining temperature values of the fuel cell stacks and for defining said predefined voltage values as a function of said temperature values.

4. An arrangement for reduced use of safety gases in a high temperature fuel cell system in accordance with claim 3, wherein said means for obtaining temperature values of the fuel cell stacks based on stack resistance information modulates an anode protection current.

5. An arrangement for reduced use of safety gases in a high temperature fuel cell system in accordance with claim 4, wherein the means for obtaining temperature values separately of the fuel cell stacks is configured for injecting a high frequency alternating voltage signal along with and on top of a direct current signal in separate routes to each group of stacks to measure stack specific resistance information, and for determining individual temperature information for each group of stacks based on said stack-specific resistance information at least to limit current values used in a stack-specific electrical anode protection.

6. An arrangement for reduced use of safety gases in a high temperature fuel cell system in accordance with claim 2, wherein the arrangement comprises:
means for displacement of reactants by purging in the emergency shutdown situation to reduce need for safety gases.

7. An arrangement for reduced use of safety gases in a high temperature fuel cell system in accordance with claim 1, wherein the arrangement comprises:
a battery source as the source of energy for providing electrical energy for the electric anode protection of the fuel cell stacks, and for operating as a transient energy buffer in island mode operation and/or for implementing UPS (Uninterruptible Power Supply) functionality of the fuel cell system.

8. An arrangement for reduced use of safety gases in a high temperature fuel cell system in accordance with claim 1, wherein the arrangement comprises:
a back-up generator as the source of energy for providing electrical energy for the electric anode protection of the fuel cell stacks, and/or for implementing UPS (Uninterruptible Power Supply) functionality of the fuel cell system.

9. A method for reduced use of safety gases in a high temperature fuel cell system, the method comprising:
feeding fuel to anode sides of fuel cells of the fuel cell system;
obtaining predefined voltage and current values;
performing electrical anode protection by supplying the predefined voltage in separate routes to at least two groups of fuel cell stacks to inhibit oxidation of anodes;
providing electrical energy from a back-up source of energy for at least a predetermined minimum time for the performing of said electrical anode protection;
separately preventing the anode protection current from exceeding a predefined maximum current value for stack group specific electrical anode protection in case of faulty stacks; and
triggering the performing of electrical anode protection in a situation where anode oxidation cannot be prohibited by feeding fuel to the anode sides of the fuel cells, an explosion safe operation being allowed in a presence of an explosive atmosphere, and specified non-safe equipment being de-energized.

10. A method in accordance with claim 9, wherein the situation is an emergency shutdown situation, where anode oxidation cannot be prohibited by feeding fuel to the anode sides of the fuel cells.

11. A method in accordance with claim 9, comprising:
obtaining temperature values of the fuel cell stacks; and
defining said predefined voltage values as a function of said temperature values.

12. A method in accordance with claim 9, comprising:
obtaining temperature values of the fuel cell stacks based on stack resistance information, which is accomplished by modulating the anode protection current.

13. A method in accordance with claim 9, comprising:
obtaining temperature values separately of the fuel cell stacks by injecting a high frequency alternating voltage signal along with, and on top of, a direct current signal in separate routes to each group of stacks to measure stack specific resistance information; and
determining individual temperature information for each group of stacks on the basis of said stack-specific resistance information at least to limit current values used in a stack-specific electric anode protection.

14. A method in accordance with claim 10, comprising:
displacing reactants by purging in the emergency shutdown situation to reduce need of safety gases.

15. A method in accordance with claim 9, comprising:
providing, via a battery source as a source of energy, electrical energy for electric anode protection of the fuel cell stacks, the battery operating as a transient energy buffer in island mode operation and/or implementing UPS (Uninterruptible Power Supply) functionality of the fuel cell system.

16. A method in accordance with claim 9, comprising:
providing, via a back-up generator as a source of energy, electrical energy for electric anode protection of the fuel cell stacks, and/or implementing UPS (Uninterruptible Power Supply) functionality of the fuel cell system.
